(19) United States
(12) Patent Application Publication
(10) Pub. No.: US 2024/0338508 A1
(43) Pub. Date: Oct. 10, 2024

(54) ELECTRONIC DEVICE AND CONTROLLING METHOD THEREOF

(71) Applicant: Samsung Electronics Co., Ltd., Suwon-si (KR)

(72) Inventor: Moon-Su KIM, Suwon-si (KR)

(73) Assignee: Samsung Electronics Co., Ltd., Suwon-si (KR)

(21) Appl. No.: 18/440,365

(22) Filed: Feb. 13, 2024

(30) Foreign Application Priority Data
Apr. 5, 2023 (KR) 10-2023-0044973
Jun. 9, 2023 (KR) 10-2023-0074485

(51) Int. Cl. G06F 30/398; G06F 17/18; G06F 111/08; G06F 119/06; G06Q 50/06

(52) U.S. Cl. CPC G06F 30/398; G06F 17/18; G06Q 50/06; G06F 2111/08; G06F 2119/06

(57) ABSTRACT

Disclosed is a method of controlling an electronic device, which includes, identifying first aggressors when at least one target victim of a plurality of logic elements in a design of an electric circuit and a plurality of aggressors are determined, the identified first aggressors having a switching time corresponding to the at least one target victim from among the plurality of aggressors, determining a number of simultaneously switching aggressors among the first aggressors by a statistical method based on a switching probability of each of the first aggressors, and calculating dynamic voltage drops caused to the at least one target victim by second aggressors of the determined number of simultaneously switching aggressors, respectively.

### CROSS-REFERENCE TO RELATED APPLICATIONS

This application claims priority under 35 U.S.C. § 119 to Korean Patent Application Nos. 10-2023-0044973 filed on Apr. 5, 2023, and 10-2023-0074485 filed on Jun. 9, 2023, respectively, in the Korean Intellectual Property Office, the disclosures of which are incorporated by reference herein in their entireties.

### BACKGROUND

Various example embodiments of the present inventive concepts described herein relate to an electronic device for analyzing a dynamic voltage drop occurring in a designed circuit and a method for controlling the same.

A power supply voltage supplied to an integrated circuit is appropriately distributed to cells in the integrated circuit through a power delivery network (PDN). In this case, when a current flows through the PDN, a power supply voltage drop occurs according to Ohm's law. This voltage drop (or IR drop) reduces the performance of the cells and may cause abnormal operation of the circuit.

A dynamic voltage drop (DVD) refers to a voltage drop due to a current flowing in a situation in which an input is switching, that is, the situation in which a circuit performs a function. Typically, the dynamic voltage drop is analyzed using a vector (e.g., a set of inputs based on a circuit's actual operating scenario). However, vectors are prepared at a very late time in the circuit design flow, and when the vectors are not sufficient, a dynamic voltage drop analysis is missed for some cells in the circuit (e.g., a coverage issue).

Therefore, there is a need for a technique capable of analyzing dynamic voltage drops with fewer resources (e.g., runtime) without the coverage issue.

### SUMMARY

Various example embodiments of the present inventive concepts provide an electronic device capable of analyzing a dynamic voltage drop using a statistical method based on a switching probability of cells and a method for controlling the same.

According to an example embodiment of the present inventive concepts, a method of controlling an electronic device includes, identifying first aggressors when at least one target victim of a plurality of logic elements in a design of an electric circuit and a plurality of aggressors associated with the at least one target victim are determined, the identified first aggressors having a switching time corresponding to the at least one target victim from among the plurality of aggressors, determining a number of simultaneously switching aggressors among the first aggressors by a statistical method based on a switching probability of each of the first aggressors, and calculating dynamic voltage drops caused to the at least one target victim by second aggressors of the determined number of simultaneously switching aggressors among the first aggressors, respectively.

According to an example embodiment of the present inventive concepts, an electronic device includes a memory that stores a design of an electric circuit, timing window information and switching probability information of each of a plurality of logic elements in the design of the electric circuit, and a processor configured to identify first aggressors when at least one target victim of the plurality of logic elements in the design and a plurality of aggressors associated with the at least one target victim are determined, the identified first aggressors having a switching time corresponding to a switching time of the at least one target victim from among the plurality of aggressors based on the timing window information, determines a number of simultaneously switching aggressors among the first aggressors by a statistical method based on a switching probability information of each of the first aggressors included in the switching probability information, and calculates dynamic voltage drops caused to the at least one target victim by the determined number of second aggressors among the first aggressors, respectively, based on a circuit analysis method using a matrix.

According to an embodiment of the present disclosure, a non-transitory computer-readable recording medium storing computer instructions that, when executed by a processor of an electronic device, cause the electronic device to perform operations, and the operations include, identifying first aggressors when at least one target victim of a plurality of logic elements in a design of an electric circuit and a plurality of aggressors associated with the at least one target victim are determined, the identified first aggressors having a switching time corresponding to the at least one target victim from among the plurality of aggressors, determining a number of simultaneously switching aggressors among the first aggressors by a statistical method based on a switching probability of each of the first aggressors, and calculating dynamic voltage drops caused to the at least one target victim by second aggressors of the determined number among the first aggressors, respectively.

### BRIEF DESCRIPTION OF THE FIGURES

The above and other objects and features of the present inventive concepts will become apparent by describing example embodiments thereof with reference to the accompanying drawings.

FIG. 1 is a block diagram of an electronic device according to an example embodiment.

FIG. 2A is a diagram illustrating a design of an electric circuit according to an example embodiment.

FIG. 2B is a diagram illustrating a power delivery network of an electric circuit according to an example embodiment.

FIG. 3 is a flowchart illustrating a control method of an electronic device according to an example embodiment.

FIG. 4 is a diagram illustrating a timing window according to an example embodiment.

FIG. 5 is a diagram illustrating an example of a probability distribution.

FIG. 6 is a conceptual diagram illustrating aggressors related to a victim according to an example embodiment.

FIG. 7 is a flowchart illustrating a control method of an electronic device according to an example embodiment.

FIG. 8 is a flowchart illustrating a control method of an electronic device according to an example embodiment.

FIG. 9 is a block diagram illustrating a configuration of a processor according to an example embodiment.

FIG. 10 is a conceptual diagram illustrating aggressors related to a target path according to an example embodiment.

FIG. 11 is a flowchart illustrating a control method of an electronic device according to an example embodiment.

FIG. 12 is a flowchart illustrating a control method of an electronic device according to an example embodiment.

FIG. 13 is a block diagram illustrating a configuration of a processor according to an example embodiment.

### DETAILED DESCRIPTION

Hereinafter, various example embodiments of the present inventive concepts may be described to such an extent that an ordinary one in the art may implement the present inventive concepts.

When the terms “about” or “substantially” are used in this specification in connection with a numerical value, it is intended that the associated numerical value includes a manufacturing or operational tolerance (e.g., ±10%) around the stated numerical value. Further, regardless of whether numerical values are modified as “about” or “substantially,” it will be understood that these values should be construed as including a manufacturing or operational tolerance (e.g., ±10%) around the stated numerical values.

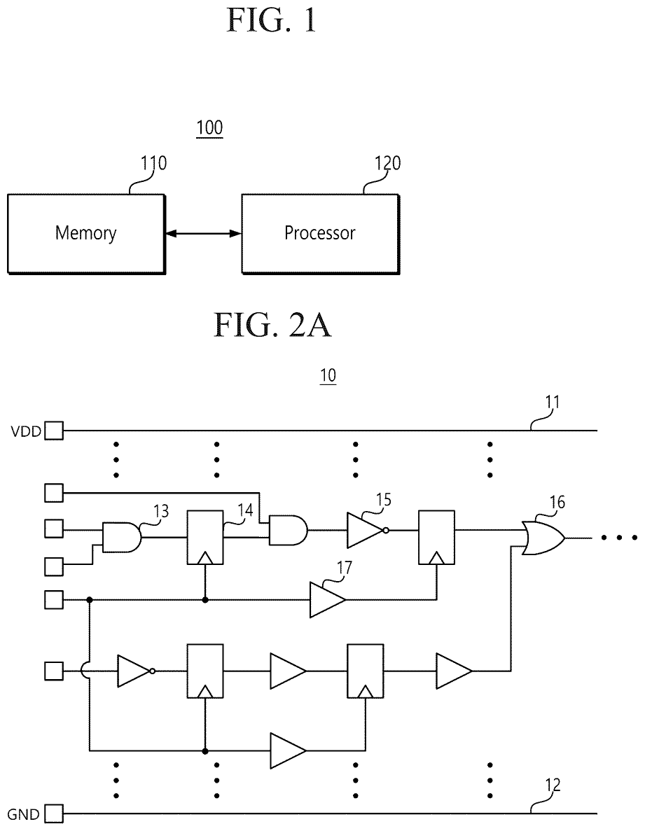

FIG. 1 is a block diagram briefly illustrating an electronic device 100 according to an example embodiment. Referring to FIG. 1, the electronic device 100 may include a memory 110 and a processor 120.

The memory 110 may store various data and programs for an operation of the electronic device 100. The memory 110 may be used as a main memory of the electronic device 100 and may include a volatile memory such as an SRAM and/or a DRAM. In addition, the memory 110 may further include a non-volatile memory such as a flash memory, a PRAM, and/or an RRAM.

According to an example embodiment, the memory 110 may store a design of an electric circuit, timing window information of each of a plurality of logic elements in the design, and switching probability information of each of the plurality of logic elements in the design.

In this case, the electric circuit may be an integrated circuit including various logic elements, but is not limited thereto. The design represents an electric circuit in a variety of ways. For example, the design may be expressed at the logic gate level, but is not limited thereto. Meanwhile, the design may include various information for expressing the electric circuit. For example, the design may include information about each of the logic elements included in the electric circuit, information about a connection relationship between the logic elements, information about a power delivery network that delivers power to each logic element, etc. However, it is not limited thereto.

The processor 120 may control overall operations of the electronic device 100. For example, the processor 120 may include one or more of a central processing unit (CPU), a controller, an application processor (AP), a microprocessor unit (MPU), a communication processor (CP), a graphics processing unit (GPU), a vision processing unit (VPU), a neural processing unit (NPU), and an ARM processor, but example embodiments are not limited thereto.

In particular, according to an example embodiment, the processor 120 may analyze or simulate a dynamic voltage drop (DVD) or timing delay of an electric circuit based on information stored in the memory 110.

In some example embodiments, when a target victim is selected from among a plurality of logic elements in the design, the processor 120 may determine a plurality of aggressors related to the selected target victim. The target victim is a logic element that is a target of dynamic voltage drop analysis among the plurality of logic elements included in an electric circuit, and may be selected by a user or the electronic device 100.

In some example embodiments, when the target victim is selected, the processor 120 may determine a plurality of aggressors from among the logic elements in the design based on the selected target victim. For example, the processor 120 may determine logic elements close to the logic element selected as a target victim as the plurality of aggressors. This is because a logic element closer to the target victim has a greater voltage drop effect on the target victim during a switching operation. Meanwhile, the number of a plurality of aggressors related to the target victim may be predetermined (or alternatively, desired). In this case, the preset number may be preset by the user or by the electronic device 100. In some example embodiments, when a plurality of aggressors related to the target victim are determined, the processor 120 may identify first aggressors having a switching time corresponding to the target victim from among the plurality of aggressors. For example, the processor 120 may identify aggressors having a timing window at least partially overlapping with a timing window of the target victim as first aggressors. This is because even if the aggressor is located close to the target victim, when the switching timing of the aggressor is different from the switching time of the target victim, it does not affect the operation of the target victim.

In some example embodiments, when the first aggressors are identified, the processor 120 may determine the number of aggressors among the first aggressors that switch simultaneously. For example, the processor 120 may determine the number of simultaneously switching aggressors by a statistical method based on a switching probability of each of the first aggressors. In this case, the statistical method may be a Monte Carlo method, but is not limited thereto.

For example, the processor 120 may perform a Monte Carlo simulation on the number of simultaneously switching aggressors based on the switching probability of each of the first aggressors. In this case, the simulation may be performed a preset number of times to obtain a probability distribution about the number of simultaneously switching aggressors. In this case, the preset number of times may be preset by a user or by the electronic device 100. In addition, the processor 120 may obtain a probability distribution regarding the number of simultaneously switching aggressors based on the performed simulation results. Accordingly, in some example embodiments, the processor 120 may determine the number of aggressors corresponding to a predetermined (or alternatively, desired) standard deviation level on the obtained probability distribution as the number of simultaneously switching aggressors. In this case, the predetermined (or alternatively, desired) standard deviation level may be set by a user or by the electronic device 100, and may be, for example, a 3 sigma level, but is not limited thereto.

Meanwhile, the processor 120 may select the determined number of aggressors among the first aggressors as the second aggressors. Accordingly, in some example embodiments, the processor 120 may calculate each of the dynamic voltage drops caused to the target victim by the second aggressors. In this case, the processor 120 may calculate each of the dynamic voltage drops based on a circuit analysis method using a matrix. For example, the processor 120 may calculate each of the dynamic voltage drops using a matrix solving method such as a SPICE (Simulation Program with Integrated Circuit Emphasis).

The dynamic voltage drops calculated as described above may be used to statistically determine a dynamic voltage drop to a target victim or statistically determine a delay time to a target path, according to an example embodiment. Details regarding this will be described in related example embodiments later.

As described above, according to an example embodiment, the dynamic voltage drop using the matrix solving method may be calculated only with respect to the second aggressors selected through a statistical method based on the switching probability of the cells. Accordingly, in some example embodiments, dynamic voltage drop analysis may be performed with fewer resources without a coverage issue.

Meanwhile, FIG. 1 illustrates the configuration of the electronic device 100 as an example, but the present inventive concepts are not limited thereto. According to an implementation example, the electronic device 100 may further include other components for performing the operation of the electronic device 100. For example, the electronic device 100 may be implemented as various computing devices such as a PC, a laptop computer, a workstation, a server device, and a simulation device, but is not limited thereto. In addition, in some cases, logic elements included in the design may be referred to as logic gates, logic cells, cells, etc., and switching may be referred to as toggle or toggling.

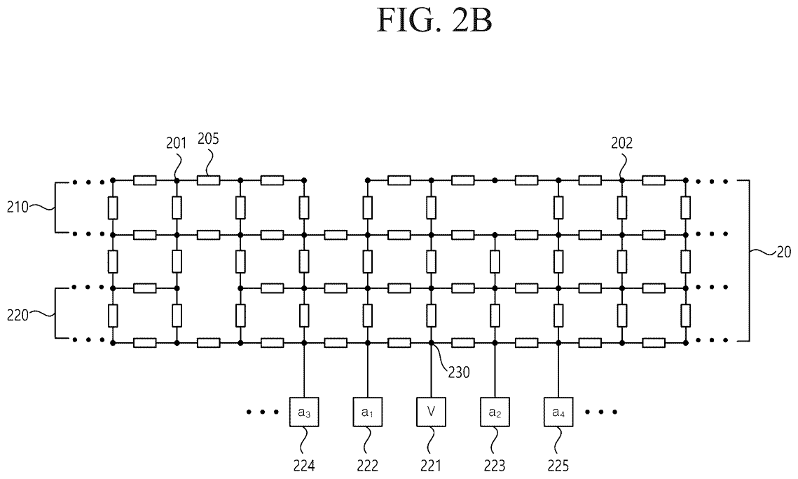

FIG. 2A is a diagram illustrating a design of an electric circuit according to an example embodiment.

Referring to FIG. 2A, an electric circuit 10 may include various logic elements such as an AND gate 13, a flip-flop 14, an inverter 15, an OR gate 16, and a buffer 17. In addition, although not illustrated in the drawing, the electric circuit 10 may further include other logic elements used in integrated circuits, such as a NAND gate, a NOR gate, etc.

Meanwhile, the electric circuit 10 may include power lines 11 and 12. The power line 11 may distribute a power supply voltage VDD, and the power line 12 may distribute a ground voltage GND. Voltages applied to the power lines 11 and 12 may be provided to logic elements in the electric circuit 10 through a power delivery network (or a power grid).

According to an example embodiment, a logic element that is a target of the dynamic voltage drop analysis among logic elements forming the electric circuit 10 may be selected as a target victim. In addition, a predetermined (or alternatively, desired) number of logic elements close to the logic element selected as the target victim may be determined as the aggressors.

FIG. 2B is a diagram illustrating a power delivery network of an electric circuit according to an example embodiment.

Rectangles 205 in FIG. 2B represent various resistive components present on a power delivery network 20. The power supply voltage applied through power nodes 201 and 202 may be provided to various logic elements through the power delivery network 20.

Although FIG. 2B illustrates a case in which the power delivery network 20 includes three layers as an example, a design in the form of an integrated circuit may have more layers in addition to an upper layer 210 and a lower layer 220.

Referring to FIG. 2B, the lower layer 220 may be connected to logic elements forming the electric circuit. In this case, the logic elements may include a target victim 221 receiving the power through a pin 230. In addition, the logic elements may include aggressors 222, 223, 224, and 225. In this case, each of the aggressors may switch between different voltage states (e.g., logic high and logic low), and a voltage drop may be caused to the pin 230 when the aggressor switches.

According to an example embodiment, the electronic device 100 selects some of the aggressors 222, 223, 224, and 225 as second aggressors, and may respectively calculate the dynamic voltage drops caused to the target victim 221 by the selected second aggressors.

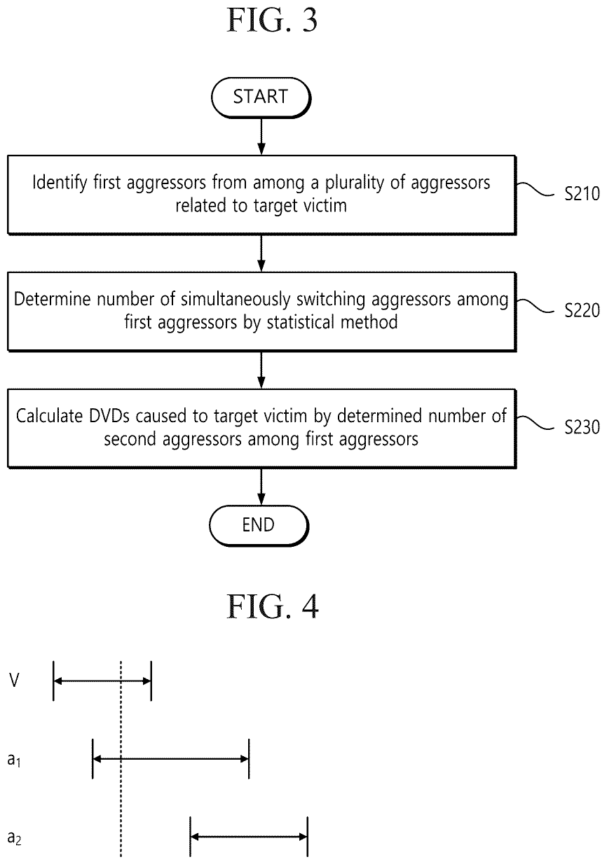

FIG. 3 to FIG. 5 are diagrams for describing a control method of an electronic device according to an example embodiment.

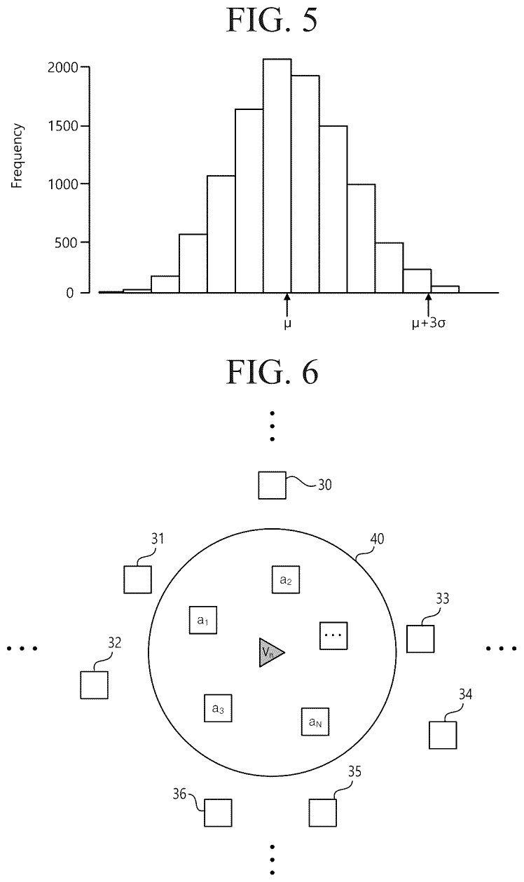

FIG. 3 is a flowchart illustrating an example of a control operation of an electronic device according to an example embodiment. FIG. 4 is a diagram illustrating an example of a timing window according to an example embodiment. FIG. 5 is a diagram illustrating an example of a probability distribution according to an example embodiment.

First, referring to FIG. 3, in operation S210, the electronic device 100 (refer to FIG. 1) may identify first aggressors from among a plurality of aggressors related to the target victim.

For example, the electronic device 100 may determine at least one target victim among a plurality of logic elements in the design of an electric circuit. In addition, the electronic device 100 may determine a plurality of aggressors related to the at least one target victim. Accordingly, in some example embodiments, the electronic device 100 may identify first aggressors from among the plurality of aggressors based on a switching time of the target victim and switching times of the plurality of aggressors.

According to an example embodiment, the electronic device 100 may identify first aggressors based on timing window information of each of a plurality of logic elements. In this case, the timing window information is information temporally representing a switching relationship of logic elements in an electric circuit.

In more detail with reference to FIG. 4, for example, the timing window of an aggressor a1 partially overlaps with that of a target victim V, but the timing window of an aggressor a2 does not overlap with that of the target victim V at all. Since the switching of the aggressor a2 has no effect on the operation of the target victim V, the aggressor a2 may be ignored in the dynamic voltage drop analysis.

Therefore, according to an example embodiment, the electronic device 100 may identify aggressors having a timing window at least partially overlapping with the timing window of the target victim among a plurality of aggressors as the first aggressors.

Meanwhile, in the above example embodiments, an example of identifying the first aggressors using the timing window is described, but the embodiment is not limited thereto.

For example, the first aggressors may also be identified through other types of information indicating a switching timing relationship between logic elements in an electric circuit.

In operation S220, the electronic device 100 may determine the number of simultaneously switching aggressors among the first aggressors by a statistical method.

According to an example embodiment, the electronic device 100 may perform a Monte Carlo simulation on the number of simultaneously switching aggressors based on the switching probability of each of the first aggressors. Accordingly, in some example embodiments, the electronic device 100 may obtain a probability distribution regarding the number of simultaneously switching aggressors.

For example, the electronic device 100 may randomly determine whether each of the first aggressors switches based on the switching probability of each of the first aggressors. In addition, the electronic device 100 may obtain data about the number of first aggressors switched according to the determination. For example, the electronic device 100 may repeat the above process 10000 times and may obtain 10000 pieces of data about the number of simultaneously switched first aggressors. The electronic device 100 may obtain a probability distribution about the number of simultaneously switching aggressors among the first aggressors by using the obtained 10000 pieces of data.

Accordingly, in some example embodiments, the electronic device 100 may determine the number of aggressors corresponding to a predetermined (or alternatively, desired) standard deviation level (e.g., 3 sigma level) on the obtained probability distribution as the number of simultaneously switching aggressors among the first aggressors.

For example, when FIG. 5 illustrates the probability distribution of the number of simultaneously switching aggressors, μ represents the average value of the number of simultaneously switching aggressors, and μ+30 represents the number of simultaneously switching aggressors corresponding to the 3 sigma level.

The number of simultaneously switching aggressors determined as above becomes a criterion for determining second aggressors thereafter. The second aggressors may be subject to dynamic voltage drop calculation using a matrix solving method.

Meanwhile, as the number of simultaneously switching aggressors increases, the dynamic voltage drop caused to the target victim increases. However, the case where all first aggressors switch at the same time may be unlikely to occur. Therefore, in some example embodiments, by appropriately selecting the number of simultaneously switching aggressors, it is possible to cover a case in which a large dynamic voltage drop occurs, which may occur without calculating the dynamic voltage drop for all first aggressors.

According to an example embodiment, the electronic device 100 may determine a value corresponding to a 3 sigma level on the obtained probability distribution as the number of simultaneously switching aggressors. Since the 3 sigma level includes about 99.73% of values on the probability distribution, it may sufficiently cover the worst cases among actual switching situations of aggressors. However, the example embodiment is not limited thereto, and a standard deviation level greater than 3 may be used to cover worst cases, or a standard deviation level less than 3 may be used for faster dynamic voltage drop calculation.

In operation S230, the electronic device 100 may respectively calculate dynamic voltage drops caused to at least one target victim by the determined number of second aggressors among the first aggressors.

In some example embodiments, the electronic device 100 may estimate dynamic voltage drops caused to the target victim by the first aggressors using an artificial intelligence model. In addition, the electronic device 100 may calculate an expected value of a dynamic voltage drop by each of the first aggressors by multiplying each of the estimated dynamic voltage drops by a switching probability of the corresponding aggressor. Accordingly, in some example embodiments, the electronic device 100 may select the determined number of second aggressors from among the first aggressors in order of having a high expected value of the dynamic voltage drop. In this case, the method using the artificial intelligence model is less accurate than the method using the matrix solving method below, but may estimate the dynamic voltage drop caused by the aggressors at a much faster speed.

Accordingly, in some example embodiments, the electronic device 100 may calculate dynamic voltage drops by the second aggressors, respectively, using a circuit analysis method using a matrix, for example, a matrix solving method widely known in the SPICE.

As described above, the dynamic voltage drops calculated in this way may be used to statistically determine a dynamic voltage drop to a target victim or to statistically determine a delay time to a target path.

Hereinafter, example embodiments of statistically determining a dynamic voltage drop with respect to a target victim will be described with reference to FIGS. 6 to 9.

FIG. 6 is a conceptual diagram illustrating aggressors related to a victim according to an example embodiment. According to an example embodiment, the electronic device 100 may statistically determine a dynamic voltage drop with respect to one logic element selected from among a plurality of logic elements included in the design of an electric circuit. In this case, one selected logic element may become the target victim. Vₙ in FIG. 6 represents an example of one target victim selected in this way.

In some example embodiments, when a target victim is selected, the electronic device 100 may select a plurality of logic elements of a predetermined (or alternatively, desired) number close to the target victim as a plurality of aggressors. This is because the effect of the dynamic voltage drop on the target victim is greater as logic elements are closer to the target victim. In FIG. 6, a₁, a₂, a₃, . . . , a_{N} represents an example of N aggressors determined to be related to Vₙ.

Meanwhile, logic elements 31, 32, 33, 34, 35, and 36 located outside a specific area 40 around Vₙ may not be included in the aggressors related to Vₙ. In FIG. 6, for convenience of illustration, the specific area 40 including a target victim and a plurality of aggressors is illustrated in a circular shape, but the shape is not limited thereto.

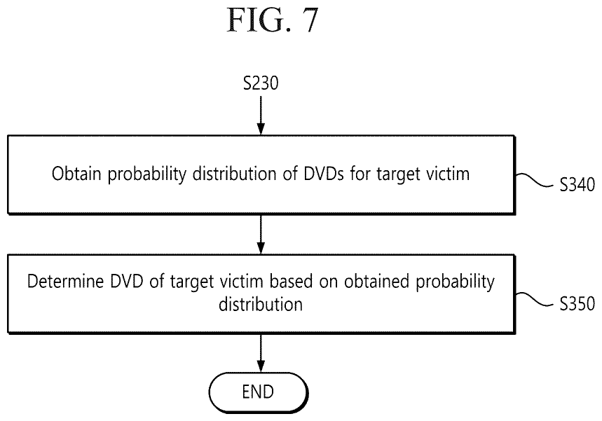

FIG. 7 is a flowchart illustrating a control method of an electronic device according to an example embodiment.

Referring to FIG. 7, in operation S340, the electronic device 100 may obtain a probability distribution of dynamic voltage drops with respect to the target victim. In some example embodiments, when the dynamic voltage drops caused to the target victim by the second aggressors are calculated in operation S230 of FIG. 3, the electronic device 100 may obtain a probability distribution of dynamic voltage drops with respect to the target victim by a statistical method, based on the calculated dynamic voltage drops and the switching probability of each of the second aggressors.

According to an example embodiment, the electronic device 100 may perform a Monte Carlo simulation on the dynamic voltage drops with respect to the target victim based on the calculated dynamic voltage drops and the switching probability of each of the second aggressors. Accordingly, in some example embodiments, the electronic device 100 may obtain a probability distribution of dynamic voltage drops with respect to the target victim based on the Monte Carlo simulation result.

For example, in operation S350, the electronic device 100 may determine a dynamic voltage drop corresponding to a predetermined (or alternatively, desired) standard deviation level (e.g., 3 sigma level) in the obtained probability distribution as the dynamic voltage drop with respect to the target victim.

For example, when FIG. 5 illustrates the probability distribution of dynamic voltage drops with respect to the target victim, μ in FIG. 5 represents the average value of the dynamic voltage drops with respect to the target victim, and μ+30 represents a dynamic voltage drop value with respect to the target victim corresponding to the 3 sigma level.

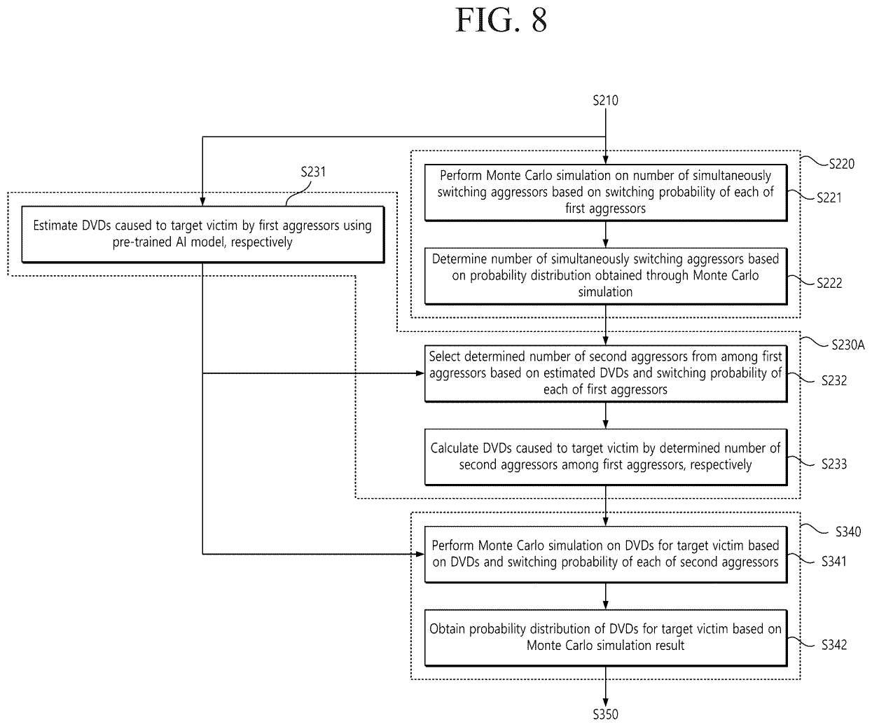

FIG. 8 is a flowchart illustrating a control method of an electronic device according to an example embodiment. In the description of FIG. 8, descriptions of overlapping contents with those described above will be omitted or simplified to avoid redundancy. In addition, in FIG. 8, a case in which N first aggressors having the switching time corresponding to the switching time of the target victim are identified through operation S210 of FIG. 3 will be described as an example.

Referring to FIG. 8, in operation S221, the electronic device 100 may perform a Monte Carlo simulation on the number of simultaneously switching aggressors based on the switching probability of each of the first aggressors. In addition, the electronic device 100 may obtain a probability distribution regarding the number of simultaneously switching aggressors based on the Monte Carlo simulation result.

For example, in operation S222, the electronic device 100 may determine the number of aggressors corresponding to a predetermined (or alternatively, desired) standard deviation level on the obtained probability distribution as the number of simultaneously switching aggressors among the first aggressors. For example, the electronic device 100 may determine the number of simultaneously switching aggressors based on Equation 1 below.

$${N}^{′} = {μ}_{K} + S \times {σ}_{K} \qquad [ Equation 1 ]$$

Here, ‘N′’ denotes the number of simultaneously switching aggressors among the first aggressors, μ_{K} and σ_{K} denote the average and standard deviation in a probability distribution ‘K’ related to the number of simultaneously switching aggressors, respectively, and ‘S’ denotes a preset standard deviation level.

Therefore, for example, when the preset standard deviation level is the 3 sigma level, ‘N′’ may be determined as μₖ+3σK. Meanwhile, ‘N′’ May be an Integer Smaller than ‘N’.

In operation S230A, the electronic device 100 may respectively calculate dynamic voltage drops caused to the target victim by the determined number of second aggressors among the first aggressors.

For example, the electronic device 100 may select the determined number, that is, N′ number of second aggressors from among the first aggressors. For example, in operation S231, the electronic device 100 may estimate dynamic voltage drops caused to the target victim by the first aggressors by using a pre-trained artificial intelligence model. In this case, when information about the design of the circuit, information about the target victim, information about the aggressors, and information about the relationship between the target victim and the aggressors are input, the artificial intelligence model may be an artificial intelligence model trained to output the dynamic voltage drop caused to the target victim by each aggressor. For example, the artificial intelligence model may be an artificial intelligence model that outputs a dynamic voltage drop caused to the target victim by each aggressor when a physical distance of each aggressor from the target victim, an input switching timing of the target victim and the aggressor, and an output load are input, but is not limited thereto.

For example, in operation S232, the electronic device 100 may select the determined number of second aggressors in order of having high expected value of the dynamic voltage drops based on the estimated dynamic voltage drops and the switching probability of each of the first aggressors. For example, the electronic device 100 may calculate an expected value of dynamic voltage drop by each of the first aggressors by multiplying each of the dynamic voltage drops estimated using the artificial intelligence model by the switching probability of the corresponding first aggressor. Accordingly, in some example embodiments, the electronic device 100 may arrange the calculated dynamic voltage drop expected values in order of size, and may select the N′ aggressors in order of causing a high dynamic voltage drop expected value. In this case, the selected N′ aggressors may become the second aggressors.

In some example embodiments, when the second aggressors are selected, in operation S233, the electronic device 100 may calculate dynamic voltage drops caused to the target victim by the selected second aggressors. In this case, the electronic device 100 may calculate each of the dynamic voltage drops caused by the second aggressors using a matrix solving method widely known in the SPICE, but is not limited thereto.

Meanwhile, in operation S340, the electronic device 100 may obtain the probability distribution of dynamic voltage drops for the target victim by a statistical method based on the dynamic voltage drops calculated in operation S233 and the switching probability of each of the second aggressors.

In operation S341, the electronic device 100 may perform a Monte Carlo simulation on the dynamic voltage drops of the target victim based on the calculated dynamic voltage drops and the switching probability of each of the second aggressors. In addition, in operation S342, the electronic device 100 may obtain a probability distribution of dynamic voltage drops with respect to the target victim based on the Monte Carlo simulation result.

According to an example embodiment, the electronic device 100 may perform the Monte Carlo simulation based on Equation 2 below and may obtain a probability distribution of dynamic voltage drops with respect to the target victim.

$$Y = ( {a}_{1} \times {X}_{1} ) + ( {a}_{2} \times {X}_{2} ) + ( {a}_{3} \times {X}_{3} ) + … + ( {a}_{{N}^{′}} \times {X}_{N ′} ) \qquad [ Equation 2 ]$$

Here, ‘a’ is a dynamic voltage drop value by each of the N′ number of second aggressors and represents a value calculated in operation S233, ‘X’ represents a random variable having a switching probability of the corresponding second aggressor, and ‘Y’ represents the statistical dynamic voltage drop value with respect to the target victim.

For example, the electronic device 100 may randomly determine whether each of the second aggressors switches based on a switching probability of each of the second aggressors, and may obtain the ‘Y’ value accordingly. The electronic device 100 may repeat the above process, for example, 10000 times, and may obtain data about 10000 Y values. The electronic device 100 may obtain a probability distribution of dynamic voltage drops with respect to the target victim using the obtained 10000 pieces of data.

Meanwhile, according to an example embodiment, when a probability distribution of dynamic voltage drops for the target victim is obtained, the electronic device 100 may additionally use the dynamic voltage drop values estimated through operation S231. The electronic device 100 may perform the Monte Carlo simulation on the dynamic voltage drops of the target victim based on the dynamic voltage drops calculated through operation S233, the switching probability of each of the second aggressors, the dynamic voltage drops by the remaining aggressors excluding the second aggressors among the dynamic voltage drops estimated through operation S231, and the switching probability of each of the remaining aggressors. Accordingly, in some example embodiments, the electronic device 100 may obtain a probability distribution of dynamic voltage drops with respect to the target victim based on the Monte Carlo simulation result.

For example, the electronic device 100 may perform the Monte Carlo simulation based on Equation 3 below and may obtain a probability distribution of dynamic voltage drops with respect to the target victim.

$${Y}^{′} = ( {a}_{1} \times {X}_{1} ) + ( {a}_{2} \times {X}_{2} ) + ( {a}_{3} \times {X}_{3} ) + … + ( {a}_{{N}^{′}} \times {X}_{{N}^{′}} ) + ( {a}_{{N}^{′} + 1} \times {X}_{{N}^{′} + 1} ) + ( {a}_{{N}^{′} + 2} \times {X}_{{N}^{′} + 2} ) + … + ( {a}_{N} \times {X}_{N} ) \qquad [ Equation 3 ]$$

Here, a₁ to aₙ are dynamic voltage drop values by each of the N′ number of second aggressors and denote values calculated in operation S233, X₁ to X_{N′} respectively denote random variables having a switching probability of the corresponding second aggressor, a_{N′+1} to an are dynamic voltage drop values by each of the remaining aggressors excluding N′ second aggressors among N first aggressors and represent values estimated in operation S231, each of X_{N′+1} to X_{N} represents a random variable having a switching probability of the corresponding remaining aggressor, and Y′ represents the statistical dynamic voltage drop value with respect to the target victim.

For example, the electronic device 100 may randomly determine whether each of the second aggressors switches based on the switching probability of each of the second aggressors. In addition, the electronic device 100 may randomly determine whether each of the remaining aggressors switches based on the switching probability of each of the remaining aggressors. Accordingly, the Y′ value may be obtained. The electronic device 100 may repeat the above process, for example, 10000 times, and may obtain data about 10000 Y′ values. The electronic device 100 may obtain a probability distribution of dynamic voltage drops with respect to the target victim using the obtained 10000 pieces of data.

In operation S350, the electronic device 100 may determine a dynamic voltage drop value corresponding to a predetermined (or alternatively, desired) standard deviation level (e.g., 3 sigma level) in the obtained probability distribution as the dynamic voltage drop with respect to the target victim.

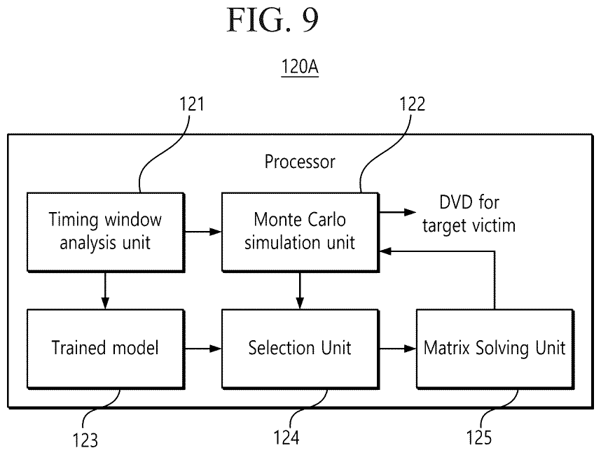

FIG. 9 is a block diagram illustrating a configuration of a processor according to an example embodiment. In describing FIG. 9, descriptions of overlapping contents with those described above will be omitted or simplified to avoid redundancy. Referring to FIG. 9, a processor 120A may include a timing window analysis unit 121, a Monte Carlo simulation unit 122, a trained model 123, a selection unit 124, and a matrix solving unit 125. At this time, each unit may be a function module or software IP (Intellectual Property) in the form of software capable of performing functions by the processor 120A, but is not limited thereto.

The timing window analysis unit 121 may identify first aggressors from among a plurality of aggressors related to the target victim. In this case, the first aggressors may have a switching time corresponding to that of the target victim. For example, the timing window analysis unit 121 may identify aggressors having a timing window at least partially overlapping with the timing window of the target victim as first aggressors. Identification information about the first aggressors may be provided to the Monte Carlo simulation unit 122 and the trained model 123.

The Monte Carlo simulation unit 122 may perform a Monte Carlo simulation and may obtain a probability distribution based on the simulation result. According to an example embodiment, the Monte Carlo simulation unit 122 may perform a Monte Carlo simulation on the number of simultaneously switching aggressors based on the switching probability of each of the first aggressors. In addition, the Monte Carlo simulation unit 122 may obtain a probability distribution regarding the number of simultaneously switching aggressors based on the simulation result. Accordingly, the Monte Carlo simulation unit 122 may determine the number of aggressors corresponding to a predetermined (or alternatively, desired) standard deviation level in the obtained probability distribution as the number of simultaneously switching aggressors.

The trained model 123 may output a dynamic voltage drop caused to the target victim by the aggressors when information about the target victim and the aggressors is input.

According to an example embodiment, when the physical distance of each of the aggressors from the target victim, the input switching timing of the target victim and the aggressors, and the output load are input, the trained model 123 may be an artificial intelligence model that outputs the dynamic voltage drop caused to the target victim by each of the aggressors.

Therefore, in some example embodiments, the trained model 123 may receive the physical distance of each of the first aggressors from the target victim, the input switching timing of the target victim and the first aggressors, and the output load, and may estimate the dynamic voltage drop caused to the target victim by each of the first aggressors.

The selection unit 124 may select a specific number of second aggressors from among the first aggressors. In this case, the specific number may be the number of simultaneously switching aggressors determined by the Monte Carlo simulation unit 122. For example, the selection unit 124 multiplies each of the dynamic voltage drops of the first aggressors estimated by the trained model 123 by the switching probability of the corresponding first aggressor to calculate the dynamic voltage drop expected value by each of the first aggressors. In addition, the electronic device 100 may arrange the calculated dynamic voltage drop expected values in order of size. Accordingly, in some example embodiments, the selection unit 124 may select the specific number of second aggressors from among the first aggressors in order of having a high dynamic voltage drop expected value.

The matrix solving unit 125 may calculate dynamic voltage drops caused to the target victim by the second aggressors selected by the selection unit 124, respectively. In this case, the matrix solving unit 125 may calculate dynamic voltage drops caused by the second aggressors, respectively, using a matrix solving method widely known in the SPICE.

Meanwhile, the Monte Carlo simulation unit 122 may perform the Monte Carlo simulation on the dynamic voltage drops of the target victim based on the dynamic voltage drops calculated by the matrix solving unit 125 and the switching probability of each of the second aggressors. Accordingly, in some example embodiments, the Monte Carlo simulation unit 122 may obtain a probability distribution of dynamic voltage drops with respect to the target victim based on the simulation result. In addition, the Monte Carlo simulation unit 122 may determine a dynamic voltage drop corresponding to a predetermined (or alternatively, desired) standard deviation level in the obtained probability distribution as the dynamic voltage drop with respect to the target victim.

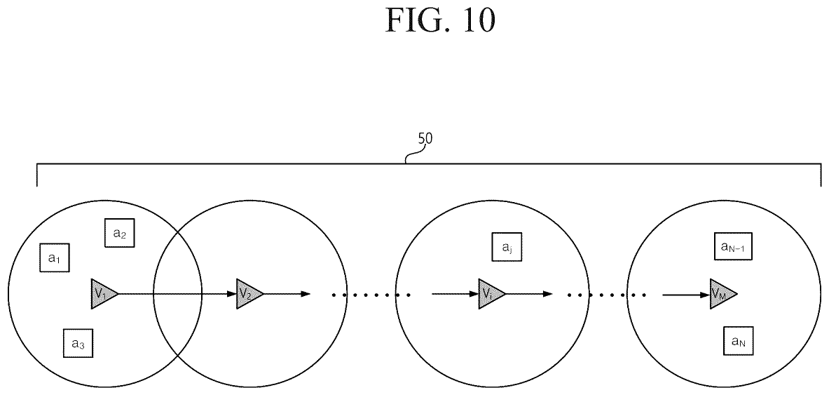

Hereinafter, example embodiments of statistically determining a delay time with respect to a target path will be described in detail with reference to FIGS. 10 to 13.

The dynamic voltage drop reduces the performance of the logic elements in the circuit. Specifically, a dynamic voltage drop caused to a logic element causes a delay of a signal processed by the corresponding logic element, which may cause a circuit malfunction. Therefore, it is necessary (or advantageous) to analyze the delay time caused on the target path due to the dynamic voltage drop when circuits are designed.

FIG. 10 is a conceptual diagram illustrating aggressors related to a target path according to an example embodiment. According to an example embodiment, a target path 50 may include a plurality of target victims V₁, V₂, . . . Vᵢ, . . . V_{M} within the design of an electric circuit. In this case, the plurality of target victims may be connected in series to each other as illustrated such that the input signal is continuously transferred through each target victim, but is not limited thereto.

In addition, each of the plurality of target victims V₁, V₂, . . . Vᵢ, . . . V_{M} may include a predetermined (or alternatively, desired) number of aggressors close to the corresponding target victim.

According to an example embodiment, when the target path 50 is specified within the design, the electronic device 100 may determine the plurality of aggressors related to the target path 50. For example, the electronic device 100 may identify a plurality of target victims included in the target path 50. In addition, the electronic device 100 may determine a preset number of aggressors close to each target victim. Accordingly, in some example embodiments, the electronic device 100 may determine the determined aggressors as a plurality of aggressors related to the target path.

Accordingly, in some example embodiments, the electronic device 100 may identify first aggressors from among the plurality of aggressors within the target path. For example, the electronic device 100 may identify aggressors having timing windows at least partially overlapping timing windows of a plurality of target victims as first aggressors. For example, the electronic device 100 may identify the corresponding aggressor as the first aggressor when at least a part of the timing window of the aggressor overlaps with any one of the timing windows of the target victims.

Meanwhile, the electronic device 100 may determine the number of simultaneously switching aggressors among the first aggressors. For example, the electronic device 100 may determine the number of simultaneously switching aggressors by a statistical method based on the switching probability of each of the first aggressors.

Meanwhile, the processor 120 may select the determined number of aggressors among the first aggressors as the second aggressors. Accordingly, in some example embodiments, the electronic device 100 may calculate dynamic voltage drops caused to the plurality of target victims V₁, V₂, . . . Vᵢ, . . . V_{M} forming the target path by the second aggressors, respectively.

For example, in FIG. 10, when an aggressor aⱼ is a second aggressor, the electronic device 100 may respectively calculate the dynamic voltage drops caused to the plurality of target victims V₁, V₂, . . . Vᵢ, . . . V_{M} by the aggressor aⱼ for each target victim.

Thereafter, the electronic device 100 may convert the calculated dynamic voltage drops into delay times caused to the target path by each of the second aggressors, and may obtain a delay time with respect to the target path based on the converted delay time.

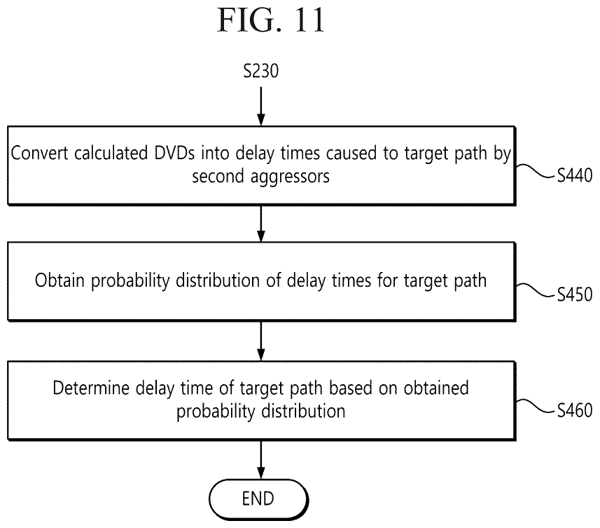

FIG. 11 is a flowchart illustrating a control method of an electronic device according to an example embodiment. Referring to FIG. 11, in operation S440, the electronic device 100 may convert the calculated dynamic voltage drops into delay times caused to the target path by the second aggressors.

For example, as described above, the electronic device 100 may calculate dynamic voltage drops caused to each of the plurality of target victims by each of the second aggressors. Accordingly, in some example embodiments, the electronic device 100 may add the dynamic voltage drops caused to each of the plurality of target victims for each second aggressor. In this case, the added value may be a dynamic voltage drop caused to the target path by the corresponding second aggressor. For example, the electronic device 100 adds the dynamic voltage drops caused to each of the plurality of target victims V₁, V₂, . . . Vᵢ, . . . V_{M} by the second aggressor aⱼ to calculate the dynamic voltage drop caused to the target path by the second aggressor aⱼ.

Accordingly, in some example embodiments, the electronic device 100 may convert the dynamic voltage drop caused to the target path by the second aggressor into a delay time caused to the target path by the second aggressor. According to an example embodiment, the electronic device 100 may store a mapping table for converting a dynamic voltage drop into a delay time in advance. Accordingly, in some example embodiments, the electronic device 100 may convert a dynamic voltage drop into a delay time based on a pre-stored mapping table, but is not limited thereto.

Meanwhile, in operation S450, the electronic device 100 may obtain a probability distribution of delay times with respect to the target path by a statistical method based on the converted delay times and the switching probability of each of the second aggressors.

According to an example embodiment, the electronic device 100 may the perform Monte Carlo simulation on delay times of the target path based on the converted delay times and the switching probability of each of the second aggressors. In addition, the electronic device 100 may obtain a probability distribution of delay times with respect to the target path based on the Monte Carlo simulation result.

In operation S460, the electronic device 100 may determine a delay time value corresponding to a predetermined (or alternatively, desired) standard deviation level (e.g., 3 sigma level) in the probability distribution of delay times for the target path as the delay time value for the target path.

For example, when FIG. 5 illustrates a probability distribution of delay times for a target path, μ in FIG. 5 may represent an average value of delay times for the target path, and μ+3σ may represent the delay time for a target path corresponding to the 3 sigma level.

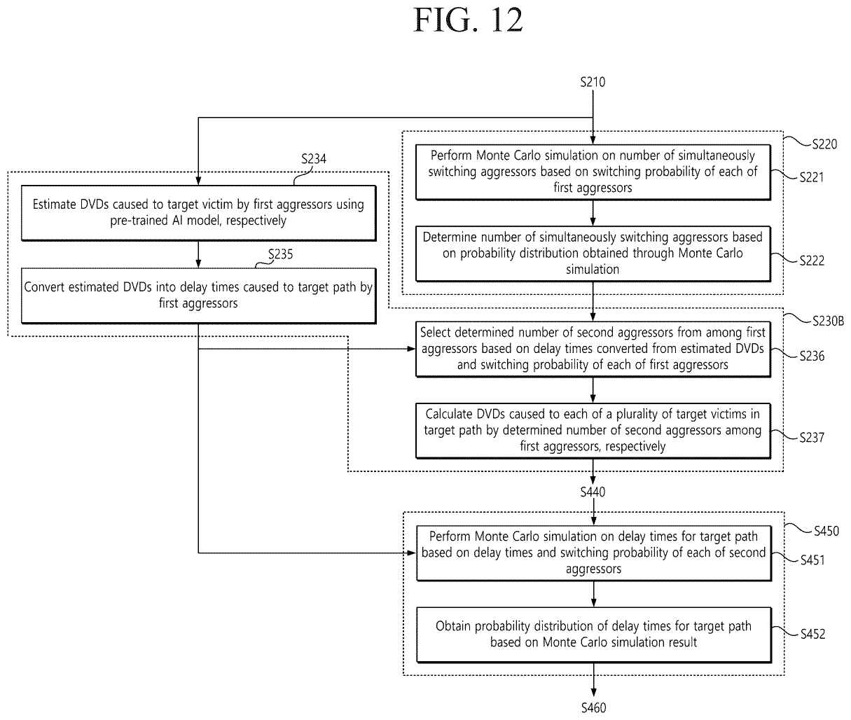

FIG. 12 is a flowchart illustrating a control method of an electronic device according to an example embodiment. In describing FIG. 12, descriptions of overlapping contents with those described above will be omitted or simplified to avoid redundancy. In addition, in FIG. 12, a case in which N first aggressors having the switching time corresponding to the switching time of the target victim are identified through operation S210 of FIG. 3 will be described as an example.

Referring to FIG. 12, in operation S221, the electronic device 100 may perform a Monte Carlo simulation on the number of simultaneously switching aggressors based on the switching probability of each of the first aggressors. In addition, the electronic device 100 may obtain a probability distribution regarding the number of simultaneously switching aggressors based on the Monte Carlo simulation result.

In operation S222, the electronic device 100 may determine the number of aggressors (e.g., N′) corresponding to a predetermined (or alternatively, desired) standard deviation level in the obtained probability distribution as the number of simultaneously switching aggressors among the first aggressors. Since the example related to operation S220 is the same as described above with reference to FIG. 8, additional description thereof will be omitted to avoid redundancy.

In operation S230B, the electronic device 100 may respectively calculate dynamic voltage drops caused to each of the plurality of target victims included in the target path by each of the second aggressors.

For example, the electronic device 100 may select the determined number, that is, N′ number of second aggressors from among the first aggressors.

For example, in operation S234, the electronic device 100 may estimate dynamic voltage drops caused to each of a plurality of target victims by each of the first aggressors using a pre-trained artificial intelligence model.

In addition, in operation S235, the electronic device 100 may convert the estimated dynamic voltage drops into delay times caused to the target path by each of the first aggressors. For example, the electronic device 100 may add the estimated dynamic voltage drops for each first aggressor. In this case, the added value may be a dynamic voltage drop caused to the target path by the corresponding first aggressor. Accordingly, in some example embodiments, the electronic device 100 may convert the dynamic voltage drop caused to the target path by the first aggressor into a delay time caused to the target path by the first aggressor. In this case, the above-described mapping table may be used.

In operation S236, the electronic device 100 may select the N′ number of second aggressors in order of having a long delay time expected value based on the delay times converted in operation S235 and the switching probability of each of the first aggressors. For example, the electronic device 100 may arrange values obtained by multiplying each of the converted delay times by a switching probability of the corresponding first aggressor, that is, expected values of delay times, in order of size. Accordingly, in some example embodiments, the electronic device 100 may select N′ aggressors in the order of having the largest expected value among the arranged expected values. In this case, the selected N′ aggressors may become the second aggressors.

In some example embodiments, when the second aggressors are selected, in operation S237, the electronic device 100 may respectively calculate dynamic voltage drops caused to each of the plurality of target victims on the target path by each of the second aggressors. In this case, the electronic device 100 may calculate each of the dynamic voltage drops caused by the second aggressors using a matrix solving method widely known in the SPICE, but is not limited thereto.

Meanwhile, in operation S440, the electronic device 100 may convert the dynamic voltage drops calculated through operation S237 into delay times caused to the target path by the second aggressors.

Thereafter, in operation S450, the electronic device 100 may obtain a probability distribution of delay times with respect to the target path by a statistical method based on the switching probability of each of the second aggressors and the delay times converted in operation S440. For example, in operation S451, the electronic device 100 may perform the Monte Carlo simulation on delay times of the target path based on the switching probability of each of the second aggressors and the delay times converted in operation S440. In addition, in operation S452, the electronic device 100 may obtain a probability distribution of delay times with respect to the target path based on the Monte Carlo simulation result.

According to an example embodiment, the electronic device 100 may perform the Monte Carlo simulation based on Equation 4 below and may obtain a probability distribution of delay times with respect to the target path.

$$Y = ( {a}_{1} \times {X}_{1} ) + ( {a}_{2} \times {X}_{2} ) + ( {a}_{3} \times {X}_{3} ) + … + ( {a}_{{N}^{′}} \times {X}_{N ′} ) \qquad [ Equation 4 ]$$

Here, ‘a’ is a delay time value by each of the N′ second aggressors and represents a value converted in operation S440, ‘X’ represents a random variable having a switching probability of the corresponding second aggressor, and ‘Y’ represents the statistical delay time value for a target path.

For example, the electronic device 100 may randomly determine whether each of the second aggressors switches based on a switching probability of each of the second aggressors, and may obtain the ‘Y’ value accordingly. The electronic device 100 may repeat the above process, for example, 10000 times, and may obtain data about 10000 Y values. The electronic device 100 may obtain a probability distribution of delay times with respect to the target path using the obtained 10000 pieces of data.

Meanwhile, according to an example embodiment, when a probability distribution of delay times for the target path is obtained, the electronic device 100 may additionally use the delay time values converted through operation S235. For example, the electronic device 100 may perform the Monte Carlo simulation on delay times of the target path, based on the delay times converted through operation S440, the switching probability of each of the second aggressors, the delay times caused by the remaining aggressors other than the second aggressors among the delay times converted through operation S235, and the switching probability of each of the remaining aggressors. Accordingly, in some example embodiments, the electronic device 100 may obtain a probability distribution of delay times with respect to the target path based on the Monte Carlo simulation result.

For example, the electronic device 100 may perform the Monte Carlo simulation based on Equation 5 below and may obtain a probability distribution of delay times with respect to the target path.

$${Y}^{′} = ( {a}_{1} \times {X}_{1} ) + ( {a}_{2} \times {X}_{2} ) + ( {a}_{3} \times {X}_{3} ) + … + ( {a}_{{N}^{′}} \times {X}_{{N}^{′}} ) + ( {a}_{{N}^{′} + 1} \times {X}_{{N}^{′} + 1} ) + ( {a}_{{N}^{′} + 2} \times {X}_{{N}^{′} + 2} ) + … + ( {a}_{N} \times {X}_{N} ) \qquad [ Equation 5 ]$$

Here, a₁ to an are delay time values by each of the N′ number of second aggressors and denote values converted in operation S440, X₁ to X_{N′} respectively denote random variables having a switching probability of the corresponding second aggressor, a_{N′+1} to an are delay time values by each of the remaining aggressors excluding N′ second aggressors among N first aggressors and represent delay time values converted in operation S235, each of X_{N′+1} to X_{N} represents a random variable having a switching probability of the corresponding remaining aggressor, and Y′ represents the statistical dynamic delay time value with respect to the target path.

For example, the electronic device 100 may randomly determine whether each of the second aggressors switches based on the switching probability of each of the second aggressors, and may randomly determine whether each of the remaining aggressors switches based on the switching probability of each of the remaining aggressors. Accordingly, in some example embodiments, the Y′ value may be obtained. The electronic device 100 may repeat the above process, for example, 10000 times, and may obtain data about 10000 Y′ values. The electronic device 100 may obtain a probability distribution of delay times with respect to the target path using the obtained 10000 pieces of data.

In operation S460, the electronic device 100 may determine a delay time value corresponding to a predetermined (or alternatively, desired) standard deviation level (e.g., 3 sigma level) in the obtained probability distribution as the delay time with respect to the target path.

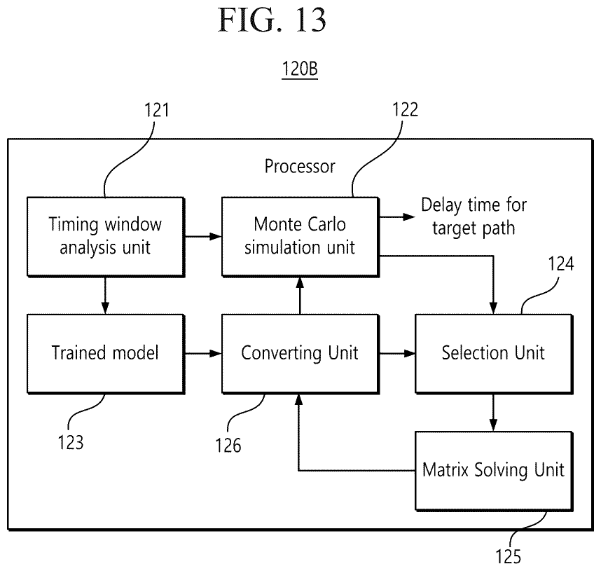

FIG. 13 is a block diagram illustrating a configuration of a processor according to an example embodiment. In the description of FIG. 13, descriptions of overlapping contents with those described above will be omitted or simplified to avoid redundancy. Referring to FIG. 13, a processor 120B may include the timing window analysis unit 121, the Monte Carlo simulation unit 122, the trained model 123, the selection unit 124, the matrix solving unit 125, a converting unit 126.

The timing window analysis unit 121 may identify first aggressors from among a plurality of aggressors. In this case, the plurality of aggressors may be aggressors related to a plurality of target victims included in one target path.

The Monte Carlo simulation unit 122 may perform a Monte Carlo simulation on the number of simultaneously switching aggressors based on the switching probability of each of the first aggressors. In addition, the Monte Carlo simulation unit 122 may obtain a probability distribution regarding the number of simultaneously switching aggressors based on the simulation result. Accordingly, in some example embodiments, the Monte Carlo simulation unit 122 may determine the number of aggressors corresponding to a predetermined (or alternatively, desired) standard deviation level in the obtained probability distribution as the number of simultaneously switching aggressors.

The trained model 123 may estimate a dynamic voltage drop caused to each of the plurality of target victims by each of the first aggressors.

The converting unit 126 may convert the dynamic voltage drop into a delay time. For example, the converting unit 126 may convert a dynamic voltage drop into a delay time using a mapping table, but is not limited thereto. According to an example embodiment, the converting unit 126 may convert the dynamic voltage drops estimated through the trained model 123 into delay times caused to a target path by each of the first aggressors.

The selection unit 124 may select a specific number of second aggressors from among the first aggressors. In this case, the specific number may be the number of simultaneously switching aggressors determined by the Monte Carlo simulation unit 122. For example, the selection unit 124 may select the second aggressors from among the first aggressors in order of having a long delay time expected value based on the delay times by the first aggressors provided by the converting unit 126 and the switching probability of each of the first aggressors.

The matrix solving unit 125 may calculate dynamic voltage drops caused to each of the plurality of target victims on the target path by each of the second aggressors selected by the selection unit 124. In this case, the matrix solving unit 125 may calculate dynamic voltage drops caused by the second aggressors, respectively, using a matrix solving method widely known in the SPICE.

Meanwhile, according to an example embodiment, the converting unit 126 may convert the dynamic voltage drops calculated by the matrix solving unit 125 into delay times caused to the target path by the second aggressors.

Accordingly, in some example embodiments, the Monte Carlo simulation unit 122 may perform a Monte Carlo simulation on the delay times with respect to the target path based on the switching probability of each of the second aggressors and the delay times converted from the calculated dynamic voltage drops. In addition, the Monte Carlo simulation unit 122 may obtain a probability distribution of delay times with respect to the target path based on the simulation result. Accordingly, in some example embodiments, the Monte Carlo simulation unit 122 may determine a delay time value corresponding to a predetermined (or alternatively, desired) standard deviation level in the obtained probability distribution of delay times with respect to the target path as the delay time with respect to the target path.

According to various example embodiments described above, the dynamic voltage drop analysis may be performed with less resources (memory usage or time) without coverage issues.

For example, most (e.g., approximately 99%) of resources (e.g., memory usage, runtime) during dynamic voltage drop analysis are used for dynamic voltage drop calculation using a matrix solving method. According to an example embodiment, since the dynamic voltage drop calculation using the matrix solving method is performed only for the second aggressors selected through the timing window analysis and the statistical method, the dynamic voltage drop analysis may be performed with fewer resources.

For example, assuming that 1000 aggressors switch with a probability of 10%, the number of simultaneously switching aggressors based on the 3 sigma level is approximately 130. Accordingly, in some example embodiments, according to the above-described example embodiment, the dynamic voltage drop may be calculated for only 130 aggressors using a matrix solving method. Comparing this with the case of calculating all the dynamic voltage drops for 1000 aggressors, the runtime is reduced by about 1/10.

Meanwhile, according to an example embodiment, the electronic device 100 may include a display and a user interface. Accordingly, in some example embodiments, the electronic device 100 may display the design of an electric circuit on the display. In addition, the electronic device 100 may receive a user input for selecting a target victim or a target path through the user interface.

According to an example embodiment, a control method of the electronic device 100 according to various example embodiments may be included in a computer program product and may be provided. The computer program product may be traded between sellers and buyers as commodities. The computer program product may be distributed in the form of a device-readable storage medium (e.g., compact disc read only memory (CD-ROM)) or online through an application store (e.g., Play Store™). In the case of online distribution, at least a part of the computer program product may be temporarily stored or temporarily created in a storage medium such as a manufacturer's server, an application store server, or a relay server's memory.

Each of components (e.g., a module or a program) according to various example embodiments may include a single entity or a plurality of entities, and some of the above-described corresponding sub-components may be omitted, or any other sub-component may be further included in various example embodiments. Alternatively or additionally, some components (e.g., modules or programs) may be combined with each other so as to form one entity, so that the functions of the components may be performed in the same or similar manner as before the combination. According to various example embodiments, operations executed by modules, program modules, or other components may be executed by a successive method, a parallel method, a repeated method, or a heuristic method. Alternatively, at least some of the operations may be executed in another order or may be omitted, or any other operation may be added.

According to an example embodiment, a dynamic voltage drop analysis may be performed with fewer resources without a coverage issue.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The above descriptions are specific example embodiments for carrying out the present inventive concepts. Example embodiments in which a design is changed simply or which are easily changed may be included in the present inventive concepts as well as an example embodiment described above. In addition, technologies that are easily changed and implemented by using the above example embodiments may be included in the present inventive concepts. While the present inventive concepts have been described with reference to various example embodiments thereof, it will be apparent to those of ordinary skill in the art that various changes and modifications may be made thereto without departing from the spirit and scope of the present inventive concepts as set forth in the following claims.

What is claimed is:

1. A method of controlling an electronic device, the method comprising:
identifying first aggressors when at least one target victim of a plurality of logic elements in a design of an electric circuit and a plurality of aggressors associated with the at least one target victim are determined, the identified first aggressors having a switching time corresponding to the at least one target victim from among the plurality of aggressors;
determining a number of simultaneously switching aggressors among the first aggressors by a statistical method based on a switching probability of each of the first aggressors; and
calculating dynamic voltage drops caused to the at least one target victim by second aggressors of the determined number of simultaneously switching aggressors among the first aggressors, respectively.

2. The method of claim 1, wherein the at least one target victim is one target victim, and further comprising:
obtaining a probability distribution of dynamic voltage drops with respect to the one target victim by the statistical method based on the calculated dynamic voltage drops and a switching probability of each of the second aggressors.

3. The method of claim 2, wherein the obtaining of the probability distribution of the dynamic voltage drops with respect to the one target victim includes:
performing a Monte Carlo simulation on the dynamic voltage drops with respect to the one target victim based on the calculated dynamic voltage drops and the switching probability of each of the second aggressors; and
obtaining the probability distribution of the dynamic voltage drops with respect to the one target victim based on a result of the Monte Carlo simulation.

4. The method of claim 2, further comprising:
determining a dynamic voltage drop corresponding to a standard deviation level in the probability distribution of the dynamic voltage drops with respect to the one target victim as the dynamic voltage drop with respect to the one target victim.

5. The method of claim 2, wherein the plurality of aggressors include:
a number of other logic elements close to a logic element corresponding to the one target victim among the plurality of logic elements.

6. The method of claim 2, wherein the identifying of the first aggressors includes:
identifying, among the plurality of aggressors, aggressors having a timing window at least partially overlapping with a timing window of the one target victim as the first aggressors.

7. The method of claim 1, wherein the determining of the number of simultaneously switching aggressors includes:
performing a Monte Carlo simulation on the number of simultaneously switching aggressors based on the switching probability of each of the first aggressors; and
determining the number of aggressors corresponding to a standard deviation level in a probability distribution obtained through the Monte Carlo simulation as the number of simultaneously switching aggressors.

8. The method of claim 2, wherein the calculating of the dynamic voltage drops, respectively includes selecting the determined number of second aggressors from among the first aggressors, and
wherein the selecting of the second aggressors includes:
estimating dynamic voltage drops caused to the one target victim by the first aggressors, respectively, using an artificial intelligence model; and
selecting the second aggressors of the determined number from among the first aggressors to have a high dynamic voltage drop expected value based on the estimated dynamic voltage drops and the switching probability of each of the first aggressors.

9. The method of claim 8, wherein the obtaining of the probability distribution of the dynamic voltage drops with respect to the one target victim includes:
performing a Monte Carlo simulation on the dynamic voltage drops with respect to the one target victim based on
the calculated dynamic voltage drops,
the switching probability of each of the second aggressors,
dynamic voltage drops caused by remaining aggressors other than the second aggressors among the estimated dynamic voltage drops, and
a switching probability of each of the remaining aggressors; and
obtaining the probability distribution of the dynamic voltage drops with respect to the one target victim based on a result of the Monte Carlo simulation.

10. The method of claim 1, wherein the calculating of the dynamic voltage drops, respectively includes:
calculating dynamic voltage drops caused to the at least one target victim by the second aggressors based on a circuit analysis method using a matrix.

11. The method of claim 1, wherein the at least one target victim is a plurality of target victims corresponding to a target path, and further comprising:
converting the calculated dynamic voltage drops into delay times caused to the target path by the second aggressors; and
obtaining a probability distribution of the delay times with respect to the target path by the statistical method based on the delay times converted from the calculated dynamic voltage drops and a switching probability of each of the second aggressors.

12. The method of claim 11, wherein the obtaining of the probability distribution of the delay times with respect to the target path includes:
performing a Monte Carlo simulation on the delay times with respect to the target path based on the delay times converted from the calculated dynamic voltage drops and the switching probability of each of the second aggressors; and
obtaining the probability distribution of the delay times with respect to the target path based on a result of the Monte Carlo simulation.

13. The method of claim 11, further comprising:
determining a delay time corresponding to a standard deviation level in the probability distribution of the delay times with respect to the target path as the delay time with respect to the target path.

14. The method of claim 11, wherein the plurality of aggressors include:
a number of other logic elements close to a logic element respectively corresponding to the plurality of target victims among the plurality of logic elements.

15. The method of claim 11, wherein the identifying of the first aggressors includes:
identifying as the first aggressors, aggressors having a timing window at least partially overlapping with timing windows of the plurality of target victims.

16. The method of claim 11, wherein the calculating of the dynamic voltage drops, respectively includes selecting the determined number of second aggressors from among the first aggressors, and
wherein the selecting of the second aggressors includes:
estimating dynamic voltage drops caused to the plurality target victims by the first aggressors, respectively, using an artificial intelligence model;
converting the estimated dynamic voltage drops into the delay times caused to the target path by the first aggressors; and
selecting the second aggressors of the determined number from among the first aggressors to have a long delay time expected value based on the delay times converted from the estimated dynamic voltage drops and the switching probability of each of the first aggressors.

17. The method of claim 11, wherein the obtaining of the probability distribution of the delay times with respect to the target path includes:
performing a Monte Carlo simulation on the delay times with respect to the target path based on
the delay times converted from the calculated dynamic voltage drops,
the switching probability of each of the second aggressors,
delay times caused by remaining aggressors other than the second aggressors among the delay times converted from the estimated dynamic voltage drops, and
a switching probability of each of the remaining aggressors; and
obtaining the probability distribution of the delay times with respect to the target path based on a result of the Monte Carlo simulation.

18. An electronic device comprising:
a memory configured to store a design of an electric circuit, timing window information and switching probability information of each of a plurality of logic elements in the design of the electric circuit; and
a processor configured to
identify first aggressors when at least one target victim of the plurality of logic elements in the design and a plurality of aggressors associated with the at least one target victim are determined, the identified first aggressors having a switching time corresponding to a switching time of the at least one target victim from among the plurality of aggressors based on the timing window information,
determine a number of simultaneously switching aggressors among the first aggressors by a statistical method based on a switching probability of each of the first aggressors included in the switching probability information, and
calculate dynamic voltage drops caused to the at least one target victim by the determined number of second aggressors among the first aggressors, respectively, based on a circuit analysis method using a matrix.

19. The electronic device of claim 18, wherein the processor is configured to:
perform a Monte Carlo simulation on the number of simultaneously switching aggressors based on the switching probability of each of the first aggressors, and determine the number of aggressors corresponding to a standard deviation level in a probability distribution obtained through the Monte Carlo simulation as the number of simultaneously switching aggressors.

20. A non-transitory computer-readable recording medium storing computer instructions that, when executed by a processor of an electronic device, cause the electronic device to perform operations, wherein the operations include:
identifying first aggressors when at least one target victim of a plurality of logic elements in a design of an electric circuit and a plurality of aggressors associated with the at least one target victim are determined, the identified first aggressors having a switching time corresponding to the at least one target victim from among the plurality of aggressors;
determining a number of simultaneously switching aggressors among the first aggressors by a statistical method based on a switching probability of each of the first aggressors; and
calculating dynamic voltage drops caused to the at least one target victim by second aggressors of the determined number among the first aggressors, respectively.
